(19) United States
(12) Patent Application Publication
(10) Pub. No.: US 2018/0308172 A1
(43) Pub. Date: Oct. 25, 2018

(54) COMPUTERIZED SYSTEM FOR LARGE-SCALE INVESTMENT CLUB, QUALIFYING FOR REGULATORY EXEMPTION

(71) Applicant: Christopher Daniels, Springfield, IL (US)

(72) Inventor: Christopher Daniels, Springfield, IL (US)

(21) Appl. No.: 15/494,756

(22) Filed: Apr. 24, 2017

(51) Int. Cl. G06Q 40/06; G06Q 40/00

(52) U.S. Cl. CPC G06Q 40/06; G06Q 40/10

(57) ABSTRACT

A system to manage a large-scale investment club with at least 1,000 members includes a module to receive investment actions from members; a module to make group investment decisions based on member voting; a module to track and store investment value of the investment club; a module to penalize members who are passive in managing club investments; and an interface for information retrieval, using a computing device, to display member benefits in the investment club.

### FIELD OF THE INVENTION

The present invention is in the field of investment clubs and self-directed retirement systems.

### BACKGROUND OF INVENTION

Investment clubs are social organizations that bring together people with a common interest in investing. According to Wikipedia, an investment club is a group of individuals who meet for the purpose of pooling money and investing; members typically meet on a periodic basis to make investment decisions as a group through a voting process and recording of minutes. There is no lower limit. Investment clubs also educate members about markets and financial issues.

There are many investment clubs in America and it is estimated that over 50,000 American are now, or in the last ten years have been, a member of such a club. Clubs vary widely based on activity of members, investment focus and purpose. Some clubs require members to be actively engaged others do not have such a requirement. Some clubs focus on certain types of investing, such as stocks versus fixed income versus commodities. Some clubs focus their attention on specific sectors, such as energy or technology.

Club membership has declined in the last two decades, from about 400,000 in 1998 to about 55,000 in 2015. The reason for the decline in membership is the rise of online trading and greater access to stock market data so that pooling resources of club members no longer generates meaningful cost-savings (the threshold point for such efficiencies has risen to a point where thousands of members would have to participate in a large-scale investment club to generate meaningful scale economies). In addition, other forms of social interaction have replaced the traditional investment club meetings, such as chat rooms, text and instant messaging, blogs and social network posts. These mass communications systems allow for thousands to share their view in an instant—as opposed to the limitations of meeting in person whereby merely dozens can gather and where the time between meetings and therefore between topical communication can be days or weeks. Consequently, there is less to gain from actually meeting in person or by pooling resources and making collective decisions. Therefore, investment club's appeal has greatly diminished.

The solution appears deceptively simple—a computer system that can bring all members together in a “virtual” club meeting thereby achieving meaningful scale economies and instant communication. But it's not that simple due to securities and investment regulations. Regulations require registration of investment companies and of securities issued by such companies. The administrative burden and the cost of compliance with such regulations make it impossible for large-scale investment club to operate. The only way to avoid the prohibitive cost and administrative burden is to qualify for exemption from such regulations—which is easy for small clubs but is essentially impossible for large-scale investment clubs. To qualify for such an exemption, every member must actively be involved in the club activities so that value is generated from their own efforts and is not generated in any meaningful way by the efforts of others—i.e. members cannot be passive beneficiaries of value creation. The prior art provided no mechanism for ensuring compliance with securities and investment regulations to enable large-scale club membership and social tools that sustain long-term member engagement and promote the educational benefits of investment club membership.

### SUMMARY

In one aspect, a computer system for an investment club that generates large-scale active participation among its membership, defined as 1,000 or more members in the investment club.

In another aspect, a system to manage a large-scale investment club with at least 1,000 members includes a module to receive investment actions from members; a module to make group investment decisions based on member voting; a module to track and store investment value of the investment club; a module to penalize members who are passive in managing club investments; and an interface for information retrieval, using a computing device, to display member benefits in the investment club.

Implementations of the system may include one or more of the following. The system enables members to participate in the investment club through an interface that could be connected via internet or tele-mobile communications. The computer system will reward those who actively participate by assigning them tokens. The computer system automatically keeps track of each participants tokens in a data base. The system automatically handles administrative tasks of the investment club through a member data base module and member communications module. Periodically, the system sends accounting reports and status notification to members. Periodically, the systems requests member action on certain items—such as a vote on investments or a vote on engaging a vendor to provide a service to members. Members that miss a certain number of votes, without good reason (which is defined by term of service), will have their membership terminated and will forfeit any benefits of membership.

Advantages of the system include one or more of the following. The system can handle large investment groups while motivating all participants to be actively involved in value creation, and monitoring and policing of the requirement, for regulatory compliance purposes, that each member has an active involvement. The system allows for large-scale investment club (defined as more than 1,000 members) encompassing a compelling reason for members to actively participate, a penalty for free riders and a means of tracking and verifying user participation to satisfy regulatory authorities that members are indeed contributing the value through their active participation. The system is novel in (a) the scalability of the system, (b) its design to ensure operation within the parameters of an available exemption from regulation, including but not limited to: (i) continuous monitoring, recording and verification of user activity, (ii) periodic prompts from the system (which may be in the form of information delivery or action requests) to users to encourage and to verify user activity; (iii) penalizing inactivity to include termination of membership; (iv) automation of administrative tasks of the investment club. The system identifies in the large group members who want to provide minimal effort of economic “free riders” benefiting from the activity of others while contributing little or no effort of their own and encourages the free riders to contribute or penalize them appropriately. The capability to weed out free-riders who make no contribution and seek only to benefit from others is an important improvement to the art and an appeal to users of the system. The system weeds out free riders by assigning usage points and tracking those points in a database. Points are assigned to users based on a range of activities but points are also detracted based on certain actions or inactivity. Those users who fail to maintain acertain level of activity points are warned and if there is no improvement, they are terminated.

The system provides an automated system for large-scale investment clubs that can operate within parameters of an eligible exemption from the regulation under the Securities Act of 1933, as amended and the investment company act of 1940, as amended. The system can help millions of people to benefit from investment club participation.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 shows an exemplary system for provisioning large-scale investment club.

FIG. 2 shows an exemplary method for handling investment management activities of the club of FIG. 1.

FIG. 3 shows an exemplary system for large-scale investment club.

FIG. 4 shows an exemplary investor dashboard that provides an easy to use interface for user input and information retrieval.

FIG. 5 shows an exemplary computer to handle a large-scale investment club.

### DESCRIPTION

A group investment management system is an online platform that facilitates the discovery, due diligence, administration and documentation, transfer of funds, and otherwise investing in asset classes and sectors in an allocation that reflects the aggregate view of all members for groups with at least 1,000 members. Investing typically includes equity and fixed income investments, but could include commodities and alternative asset classes.

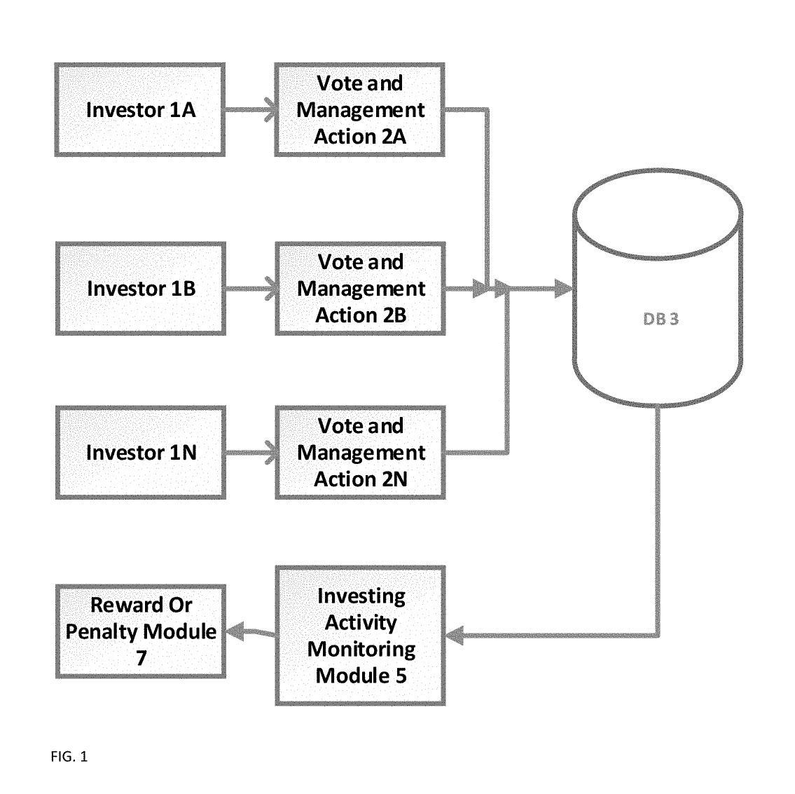

In FIG. 1, in a group with at least one thousand members, investors 1A-1N actively manages investment proposals through vote and management actions 2A-2N. The investment proposals, as discussed, identifies the target investment company and the terms of the investment. The investment is stored in database 3. The active management of each members 1A-1N is tracked by an investment activity monitoring module 5, which generates and informs members of the reward for their actions or penalties for their inactions using a reward/penalty module 7. A penalty is defined as members who fail to take actions that are either optional or required. The system automatically assigns penalty points to each member based on the severity of a member's failure to act. For example, failure to respond to an optional e-mail or an optional survey may be assigned 1 to 3 points for each occurence while failure to take a required action, like a vote, may be assigned 10 points. If a member exceeds a certain number of penalty points, the system automatically sends them a warning. If they do not correct their behavior or if their behavior worsens, their membership will be terminated.

In one embodiment, a system can operate and manage an investment club and incorporate regulatory compliance modules to ensure the investment club retains its regulatory exemption from registration under securities and investment laws and regulations even as the club scales to 1,000 members and beyond. The system has any member dashboard with or without a graphical interface to show group investment participation or activity; any module to receive and track investment actions from members, including input of a personal portfolio; any module to make group investment decisions based on member voting or based on member input of a model portfolio with a survey approach or an investment specific approach, wherein the system automatically aggregates all personal portfolios into one model portfolio for the investment club, and in a survey approach, each question is assigned points with low investment risk answers being assigned the lowest numbers and higher numbers for higher risks, wherein the computer automatically calculates a risk score for each individual and from the risk score assigns a model portfolio that is periodically adjusted by the member; any module to track and store investment value of the investment club; any module to penalize members who are passive in managing club investments, defined as members who fail to take actions that are either optional or required, wherein the module automatically assigns penalty points to each member based on the severity of a member's failure to act, wherein failure to respond to an optional e-mail or an optional survey is assigned first penalty points for each occurrence while failure to take a required action including a vote is assigned second penalty points, and for each member who exceeds a predetermined number of warning penalty points, the module automatically sends the member a warning, and for each member who exceed the predetermined number of penalty points do not correct their behavior or if member behavior worsens, the module automatically terminates membership; and an interface for information retrieval, using a computing device, to display member benefits in the investment club.

The system enables members to participate in the investment club through an interface that could be connected via internet or tele-mobile communications. The computer system will reward those who actively participate by assigning them tokens. The computer system automatically keeps track of each participants tokens in a data base. The system automatically handles administrative tasks of the investment club through a member data base module and member communications module. Periodically, the system sends accounting reports and status notification to members. Periodically, the systems requests member action on certain items—such as a vote on investments or a vote on engaging a vendor to provide a service to members. Members that miss a certain number of votes, without good reason (which is defined), will have their membership terminated and will forfeit any benefits of membership.

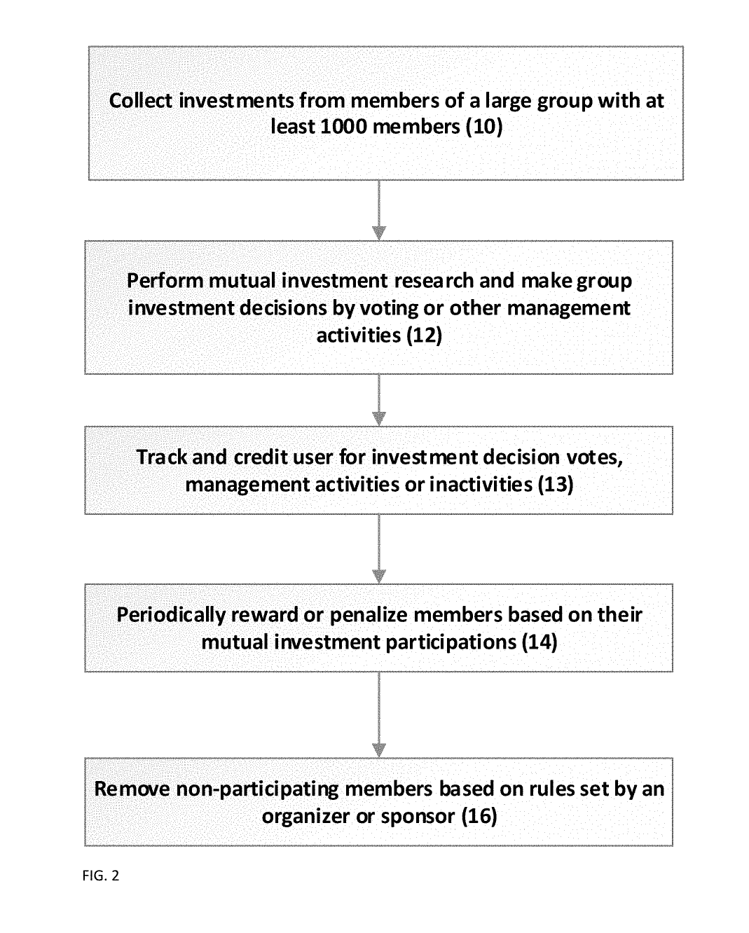

FIG. 2 is a flow diagram of an exemplary group investment process executed by the group investment management system of FIG. 1 in accordance with one aspect of the present invention. In 10, the system collects investments from members of a large group with at least 1000 members. Next, the group makes investments based on the collective decisions of the group in 12. The decisions can be made using a variety of techniques described in depth below. In 13, the system tracks user investment involvement activities, and in 14, the system can reward or penalize the members based on their group investment involvement. In 16, the system can remove members that do not provide fair contributions to the group, or alternatively, can impose a financial penalty to deter free-loaders of the group investment system.

In one embodiment, actions by the individual investor member that qualify for active management points may include an investment dashboard with one or more of the following:

1. A personal portfolio with user determined allocation by asset class and sector which includes selection, weighting and amounts of investments. The computer system would then automatically aggregate all user portfolio allocations to create a investment club model portfolio. Users can then observe how their portfolio selections conform with, or diverge from, the model portfolio. This particular functionality is important because every member of the club does their own research to construct their ideal personal portfolio and they input and periodically update their personal portfolio. They can also see how their own investment results compare to the club's aggregate model portfolio. Those whose personal portfolio far out-performs the club portfolio can be highlighted and receive special recognition thereby improving their social standing and influence in the club (see #7 below—Social Aspects). Furthermore, they know that their inputs are important because it is incorporated into the aggregate model portfolio for the club.

2. Information about tax effects of single investments and the portfolio as a whole.

3. Educational information about investing including technical factors like correlation between asset classes and sectors.

4. All shareholder rights with respect to investments in the portfolio and a means of reflecting member views by voting, and other decisions regarding such securities.

5. A vote on engaging service providers for the club such as a custodian to hold the investment club assets.

6. Ability to propose new investment opportunities to club members who can then add that to their personal portfolio—if enough members add it to their portfolio, it will be reflected in the clubs aggregate model portfolio.

7. Participation in social aspect with chat and instant messaging and blogs on specific investing topics that allows members to share experiences and to teach investment strategies and techniques to less experienced members. As described above, social interaction can be promoted by providing a means of recognizing individual member's personal portfolio results.

8. Education in investing concepts and strategies, as well as the ability to discuss investments with other investors in the investment club.

One embodiment provides a module to calculate participation and rank participation. The determination in its basic form is as follows: [LOG+PRO+ACT]/Sum of all member [LOG+PRO+ACT]; where LOG=Logins; PRO=Profile Changes; and ACT=Actions on the Member Dashboard. Of course, variations to the basic form are contemplated by the present inventor. For example, the logins can include logins from a desktop or a mobile device; the profile can include profile entered into the system and supplemented by social media profile or smart application profile or by web usage profiles such as page views or search queries entered by the user. The actions can also include comments or likes from other investing members.

In other embodiments, the system includes any module for providing social networking function among members and enabling them to search and find members with specific investment experiences, investment holdings or share experiences in a virtual private network (VPN) of members via messaging, or bulletin boards, blogs, surveys and other means of or electronic social interaction. Another module can be used that includes any social ranking of club members by investment reputation or investment performance or participation and which may take a module to generate a social rank in a form of badges, certificates, awards and which may be displayed on the website in some form of text or image which may be an online sticker or badge.

Other decisions that may be made by the members may include setting parameters for investing cash that has not been invested yet such as interest rate, credit quality and duration of uninvested funds.

Some of the items described for the investor dashboard may be specific numbers, while others can be minimums or maximums for the category. For example, an investor willing to accept non-participating preferred equity is assumed also be willing to accept participating preferred because it is considered better. Other times, members will check off a range of acceptable options when completing the offer. The system support the ability of members to parameterize the investment offerings.

In one embodiment, users of the system may select from a list of investment choices by asset class, sector or even specific securities so as to build a personal model portfolio. The system would automatically provide statistical metrics that describe the extent of diversification or concentration, the risk of the portfolio components, such as a Sharpe Ratio, a common measure of risk, and duration and volatility, in an initial round, by way of example, members of the group may first select among asset classes (equity, fixed income, commodities, US Treasury securities) or sectors (tech, energy, and healthcare). As members make choices, in some embodiments, the order in which other members are presented with choices may be updated to up-rank items that others selected. Once a round is complete, in some embodiments, selected branches of the taxonomy above may be advanced to the next round (and un-selected branches may be omitted).

To facilitate relatively prompt eventual consistency of sequences, some embodiments may store votes, options, or sequences in a real-time database, such as the real-time database offered by Firebase™ of San Francisco, Calif. In some embodiments, some or all of this data may be stored by a third party cloud-based database, e.g., in documents, like JSON or XML documents, controlled via an API of the database via requests from the various constituents of the GDE system. In some embodiments, the components of the system may open persistent transmission control protocol (TCP) connections with such a real-time database, and the real-time database may push updates to the constituent computing devices. For instance, the real-time database may send updates reflecting changes in sequences to client devices without those client devices first sending a request for updates, e.g., a pull request for changes. The persistent TCP connection may facilitate full duplex communication with multiple exchanges, rather than opening a new TCP connection at the prompting of the client device with each new request and response. In some cases, the communication is via a WebSocket connection operative to facilitate database-side pushes of updates to the client devices.

Individual may express their choices in a round with a number of different techniques. In some embodiments, items in a round of voting may be presented on a mobile device screen one at a time, like in a stack, and members may input a number of different choices, depending on the embodiment. For instance, in some embodiments, members may swipe (e.g., across a graphical icon representing the stock or investment) left to vote in favor of an item and swipe right to vote against the item. This technique offers the advantage of imposing a relatively low cognitive load on the user, though other embodiments use other techniques, like on-screen buttons, or voice commands (detecting utterances of “yes,” “no,” “veto,” “don't care,” etc.) to register votes. In another example, other swipes may express other user preferences, e.g., swipe up to indicate the user does not care whether the item is chosen and down to express that the user wishes to veto the item.

In some cases, each user may be allotted a number of vetoes (by which an item is removed without regard (or with less regard, e.g., by allotting a higher score to a veto) to how other's vote) or wildcards (by which an item is advanced without regard to, or with less regard to, others' votes) and the member device may increment or decrement a counter as such choices are made and compare those counters to a threshold in future veto/wildcard requests to determine if the user has remaining vetoes or wildcards, preventing application of such inputs in instances in which the threshold is exceeded.

In some cases, even more expressive user interactions may be supported. For instance, angle, speed, or length of a swipe (i.e., touching and dragging while maintaining contact with a touch screen, as indicated by differences in coordinates of an on-touch event and a touch-release event on the device screen) may indicate a user's degree of conviction (e.g., swiping up to the right indicates a strong approval, down to the right a low approval, up to the left a strong disapproval, and down to the left a weak disapproval). These, or other, gestures (e.g., movement of the entire mobile device, as sensed via an accelerometer) or inputs (like selection of an input button corresponding to an up-vote or down-vote on the screen, like with a mouse-click on a webpage interface) may be converted into a user score for the item, and that item may be reported by the user's instance as a vote. In some cases, decisions may cause a notification to appear on a wearable user device, like a smartwatch, and upon selection, the notification may cause a swipeable interface to be presented on the wearable, such that members may vote by swiping in the described fashion without pulling their phone out of their pocket. In such examples, votes may be conveyed by BlueTooth™ from the wearable to a smartphone and via cellular signals to the Internet. Scores may be binary (yes or no) or more granular (0 to 5) and cardinal or ordinal, in some cases, depending on the user expressions supported. More expressive votes are expected to yield group decisions with higher aggregate utility at the expense of increased cognitive load upon members.

As each user's vote is received in a round, the system may determine whether to terminate the round without waiting for further user input. Some embodiments may stop a round when every user has selected (e.g., voted in favor of) the same option. Other embodiments may continue a round until every user has selected at least a threshold number of options, providing for a more diverse set of options going forward at the expense of additional user input. Or some embodiments may wait until every user has made a decision regarding every option in a round or until a threshold amount of time allotted to a round has expired.

Depending upon the embodiment, and tradeoffs between speed/cognitive load/and fidelity to user preferences, a number of different determinations may be made by the system to ascertain whether members of a group have collectively chosen an option (e.g., a category or item at a leaf node) in a given round. In some embodiments, an option may be deemed chosen in response to more than a threshold amount of the group voting in favor of the option, or the option obtaining a threshold score based on votes, and a round may be deemed complete when a threshold amount of options are chosen, e.g., one. Such an approach favors a satisficing strategy, rather than an optimizing strategy, to expedite decisions and allow rounds to end without every group member voting on every option in that round. In some cases employing an optimizing strategy, the option that received the highest average score or was selected by the most members may be deemed the group's choice in a round. In some cases, when summing votes with the system to calculate scores for options, votes for an option may count as a plus one, votes against as a minus one, do-not-care votes as a zero, wildcard votes as a plus ten, and veto votes as a minus ten (or other suitable value for wildcards and vetoes depending upon the desired strength of these votes, like a percentage of the number of members in the group, or the number of members minus one). In another example, the top two (or some other threshold amount) highest scoring items (e.g., determined by summing the scores for all of the items in a round, or by calculating some measure of central tendency, like a mean, mode, or median) may be deemed chosen. In another example, items may first be culled according to user vetoes and advanced according to wildcards before scores are used to ascertain whether remaining items are to be advanced. When a round is complete, the system may notify members of the group to indicate that the members need not continue making selections in that round and, in some cases, to indicate the group's choice for the round.

In accordance with one aspect of the present invention, a reward, incentivization, and play system is disclosed. The group investment club system can reward actions and behaviors that its operators, users, or sponsors wish to encourage, either after the fact (an unexpected reward) or a goal or quest (series of steps) announced to club members in advance. Desirability of behaviors can be measured among other things in: investment research activities, education of people about investing, stratification by expertise and performance such as identification and social support for super-investors (as described above, things such as being “smart” money, having made successful investments, being insiders with high network or reputation value), the value to target companies or perceived social good. For examples, points, badges, encouragement, recognition, intrinsic and extrinsic awards, and other benefits may be awarded for participating on a regular schedule, investing in diverse geographical regions or business sectors. The foregoing are but a small number of the possible behaviors that may be incentivized or rewarded by the system, as nearly any behavior that can be detected and quantified may be rewarded. In the art of “gamification”, rewards are given for taking specified in-application or real-world actions such as “checking in” at a particular location, purchasing a particular thing, or otherwise using the system. The rewards system disclosed here is comparably broad, but directed at rewarding investment-related behaviors that are practiced on the group investment system.

The system may automatically calculate and display the estimated personal portfolio returns of club member/users to measure the success, ability, and status of those investor members. The system can optionally reveal, or hide, the various factors that are used to make the valuation. It can use different sources to create an estimate for the value of each security. Second Market, or other exchanges can be a source of valuation information, as may be a curation system or participation of experts or system users. If a funding is announced in the trade press, the system can guess or calculate the valuation at which it was done. The system can offer reports of option plan (409) valuations, publicly or privately stated. The system can offer Insider reports whereby company insiders or investors can anonymously (to the public) report what their company value is. The exact method of estimating the value of private company securities is not a necessary feature to the system described. Rather, in this aspect, the invention uses the valuation information, however it was obtained, to estimate and compare the aggregate performance of various member users' investment portfolios.

The system can also include an investment simulation (or game) whereby users are given imaginary money and allowed to engage in fictitious or hypothetical buying and selling. This is a parallel system by which people buy and sell securities, or engage in the group investment system, with virtual currency, i.e. a currency that is of no value and is not exchangeable for any real good or service. However, the amount can be limited and earned or given to the players, creating an in-game value even if there is no inherent value in the currency. In this aspect, investor users buying and selling private company stock on the system do create an implied exchange value for each of the companies, and can earn points and otherwise improve their reputation on the IMS through their success at this simulated investment activity. In turn, the current price of the securities in this simulated market can be used as one of the inputs to estimate the value of investors' real-world portfolio. For example, the fact that company X's stock is worth $Y in virtual currency can be evidence tending to suggest it is worth $Y in real dollars.

Other embodiments of the computer-based system and process can promote socialization of members of the large investment group to enhance engagement and participation such as discussion boards and investment education components that will give novice investors an education in investing strategies. The process and method of the various embodiments will help empower and educate individuals who currently are investors and those who want to be investors. Furthermore, the social functions have additional advantages in that:

1) it promotes the sharing of opinions and the value of each person's input;

2) it promotes research of investments, and learning about new investing opportunities;

3) it permits the investor to consider the tax effects of securities purchases and sales;

4) it permits the investor to inexpensively and timely gain opinions of experts in the investment club;

5) It permits the investor to be confident in investing through learning about investing basics, concepts, and strategies, as well as discussing investment topics with other investors.

Although the above description contains many specificities, these should not be construed as limitations on the scope of the embodiments, but as providing illustrations of one or several preferred embodiments thereof. Many other variations are possible. For example, the allocation process can be used to study and understand risk taking by individuals. The investor can allocate various percentages to investments or other risk/reward items to gauge the risk tolerance level. This can be studied by statisticians in experiments to see how various subjects react to risk and choices. Investment clubs can result in sub-groups of the club that focus on specific investment types and may lead to creation of investment funds together, make investment choices and utilize the Information Exchange message board to discuss their fund performance with other investors and group members.

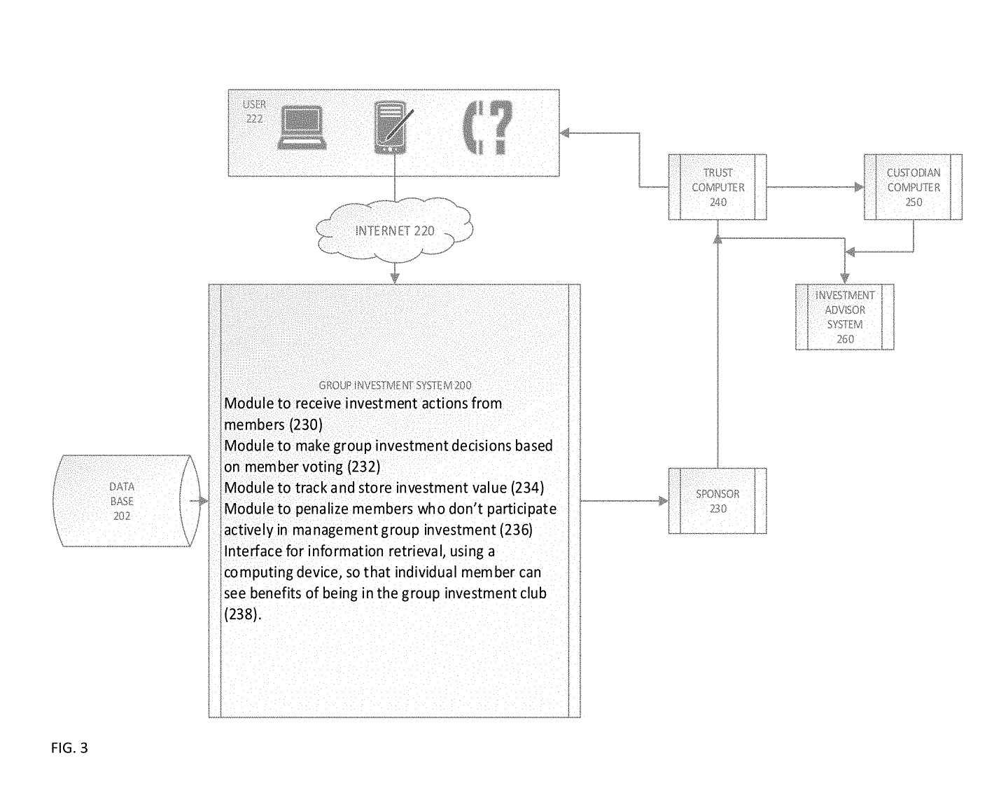

The system of FIG. 3 includes a group investment system 200 that stores data in a database 202. The system 200 communicates with a sponsor computer 230, which communicates with a trust computer 240 which in turn communicates with a custodian computer 250. The trust computer 240 and sponsor computer 230 also communicate with an investment advisor system 260.

The retirement computer system 200 communicates with the club members 222 over the internet 220 through various channels including a desktop computer, a mobile phone, a tablet, or voice communication over a telephone or POTS network.

In one embodiment, the system includes modules that performs the following: Module to receive investment actions from members or the club's designated investment advisor (230), Module to make group investment decisions based on member voting (232), Module to track and store investment value (234), Module to penalize members who don't participate actively in management group investment (236), and Interface for information retrieval, using a computing device, so that individual member can see benefits of being in the group investment club (238), among others.

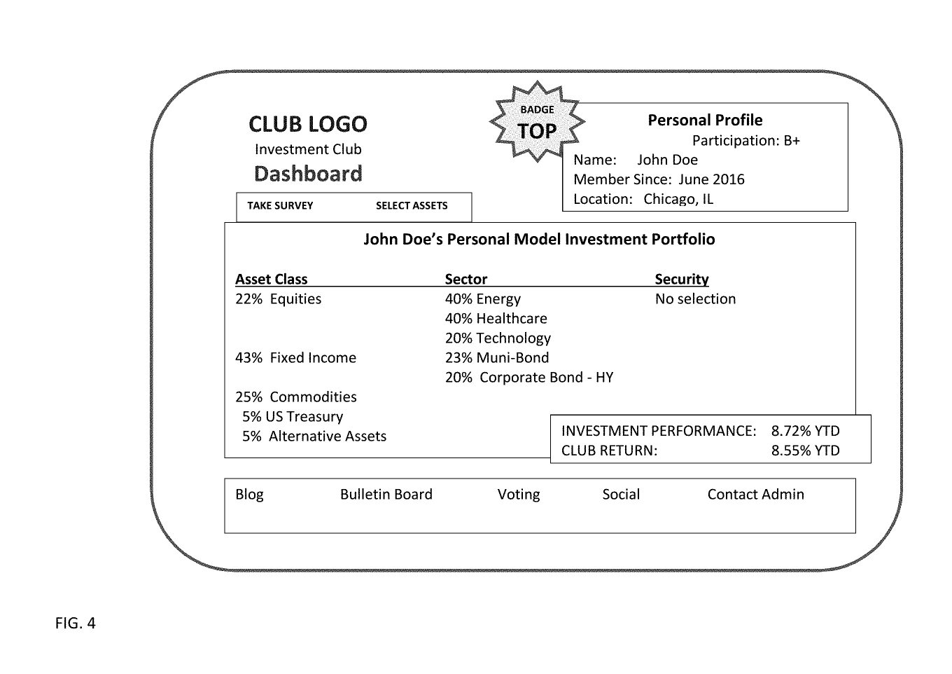

FIG. 4 shows an investor dashboard that provides an easy to use interface for user input and information retrieval. The dashboard may include dials or other graphical measuring features that are set by the investor to reflect their personal portfolio allocation. The computer system aggregates all users' personal portfolio selections to create one model portfolio for the investment club. In addition the dashboard may include features that promote and enable: (a) educational; (b) social; (c) voting on administrative matters, vendors and special investments. In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized.

Some novice users may not be ready to select specific assets or sectors or securities as their model portfolio. In one embodiment, such users will be allowed to answer questions that survey their risk tolerance and a personal portfolio that reflects such a risk tolerance is automatically created for them. There would be sufficient number of questions to determine a range of portfolios from very low risk to very high risk. Users can be offered the survey approach or a choice between survey approach and specific asset approach. In the survey approach, each answer to a question is assigned a number. Low risk answers are assigned a low number, perhaps zero. High-risk answers are assigned a high number, for example, ten. When the survey is completed, the computer system automatically calculates the survey result and assigns a portfolio based on the score. A low score portfolio will be composed of low risk investment, for example: all US Treasury securities and other high investment rade-rated fixed income investments. A high score would be composed of all high risk investments, for example, stock options and undiversified equity investments. In the preferred embodiment, there would be at least 20 model portfolios assignable based on the risk survey and each portfolio can be subsequently modified by the investment club member to overweight or underweight certain investments resulting in an increase or decrease in risk profile.

The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may be provided by sending instructions to retrieve that information from the group investment network.

The system can handle large investment groups while motivating all participants to be actively involved in value creation, and monitoring and policing of the requirement that each member has an active involvement. The system allows for large-scale investment club (defined as more than 1,000 members) encompassing a compelling reason for members to actively participate, a penalty for free riders and a means of tracking and verifying user participation to satisfy regulatory authorities that members are indeed contributing the value through their active participation. The system is novel in (a) the scalability of the system, (b) its design to ensure operation within the parameters of an available exemption from regulation, including but not limited to: (i) continuous monitoring, recording and verification of user activity, (ii) periodic prompts from the system (which may be in the form of information delivery or action requests) to users to encourage and to verify user activity; (iii) penalizing inactivity to include termination of membership; (iv) automation of administrative tasks of the investment club; (v) automatic incorporation of all club member personal portfolos into an aggregate club model portfolio. The system identifies in the large group members who want to provide minimal effort of economic “free riders” benefiting from the activity of others while contributing little or no effort of their own and encourages the free riders to contribute or penalize them appropriately. The system provides an automated system for large-scale investment clubs that can operate with parameters of an eligible exemption from the regulation under the securities act of 1933, as amended and the investment company act of 1940, as amended. The system can help millions of people to benefit from investment club participation.

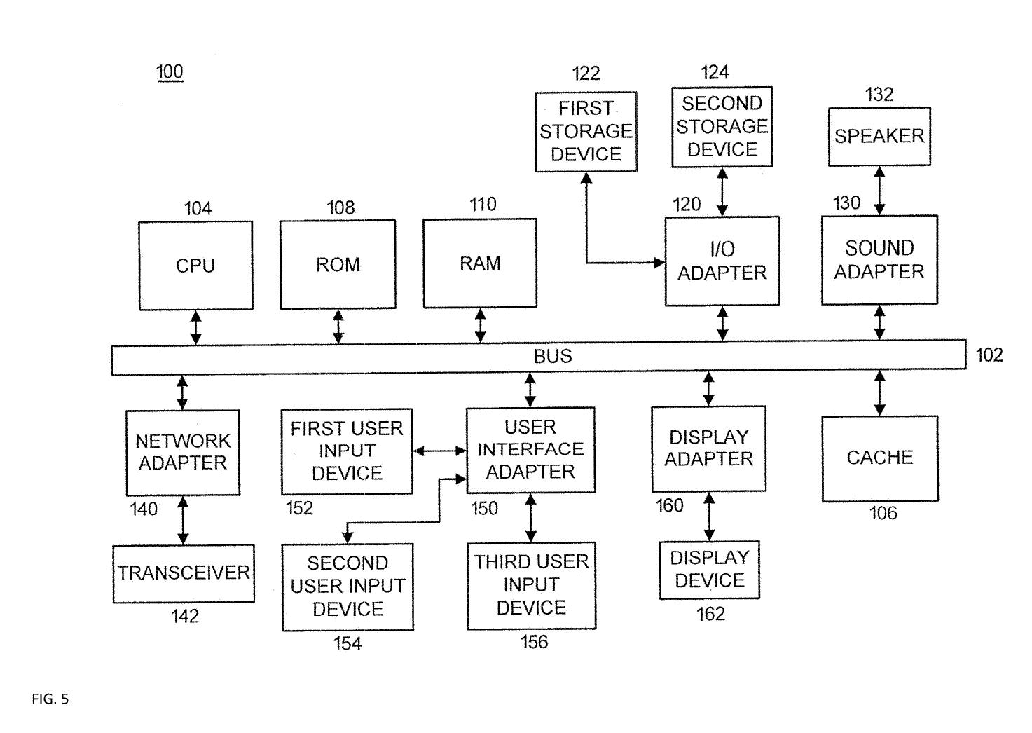

FIG. 5 shows an exemplary processing system 100, to which the present principles may be applied, is illustratively depicted in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a participant interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first participant input device 152, a second participant input device 154, and a third participant input device 156 are operatively coupled to system bus 102 by participant interface adapter 150. The participant input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The participant input devices 152, 154, and 156 can be the same type of participant input device or different types of participant input devices. The participant input devices 152, 154, and 156 are used to input and output information to and from system 100.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

What is claimed is:

1. A system to operate and manage an investment club with regulatory compliance modules to ensure the investment club retains its regulatory exemption from registration under securities and investment laws and regulations even as the club scales to 1,000 members and beyond, comprising:
any member dashboard with or without a graphical interface to show group investment participation or activity;
any module to receive and track investment actions from members, including input of a personal portfolio;
any module to make group investment decisions based on member voting or based on member input of a model portfolio with a survey approach or an investment specific approach, wherein the system automatically aggregates all personal portfolios into one model portfolio for the investment club, and in a survey approach, each question is assigned points with low investment risk answers being assigned the lowest numbers and higher numbers for higher risks, wherein the computer automatically calculates a risk score for each individual and from the risk score assigns a model portfolio that is periodically adjusted by the member;
any module to track and store investment value of the investment club;
any module to penalize members who are passive in managing club investments, defined as members who fail to take actions that are either optional or required, wherein the module automatically assigns penalty points to each member based on the severity of a member's failure to act, wherein failure to respond to an optional e-mail or an optional survey is assigned first penalty points for each occurrence while failure to take a required action including a vote is assigned second penalty points, and for each member who exceeds a predetermined number of warning penalty points, the module automatically sends the member a warning, and for each member who exceed the predetermined number of penalty points do not correct their behavior or if member behavior worsens, the module automatically terminates membership; and
an interface for information retrieval, using a computing device, to display member benefits in the investment club.

2. The system of claim 1, comprising a member dashboard with a graphical interface to show group investment participation or activity, wherein the module periodically requests member action to stay in compliance with the regulatory compliance module.

3. The system of claim 1, comprising any module to receive a vote on investments or a vote on a model portfolio that is incorporated into a master portfolio for the investment club, or a vote on engaging a vendor to provide a service to the investment club.

4. The system of claim 1, comprising any module to notify and possibly penalize a member whose participation is below a predetermined threshold.

5. The system of claim 7, comprising any module to terminate membership or code to forfeit a membership benefit.

6. The system of claim 1, comprising any module to penalize a member whose vote count is below a predetermined threshold without one or more predefined reasons.

7. The system of claim 1, comprising any module to calculate participation and rank participation as follows: [LOG+PRO+ACT]/Sum of all member [LOG+PRO+ACT]; where LOG=number of Logins; PRO=number of Profile Changes; and ACT=number of actions on the member Dashboard.

8. The system of claim 1 a module providing a social networking function among members and enabling a user to search and find members with specific investment experiences, investment holdings or share experiences in a virtual private network (VPN) of members via messaging or bulletin boards, blogs, surveys or electronic social interaction.

9. The system of claim 1, comprising a module for social ranking of club members by investment reputation or investment performance or participation and a module to generate a social rank in the form of badges, certificates, awards and which may be displayed on the website in some form of text or image which may be an online sticker or badge.

10. A system to operate and manage an investment club, comprising:
any member dashboard with or without a graphical interface to show group investment participation or activity;
any module to receive and track investment actions from members, including input of a personal portfolio;
any module to make group investment decisions based on member voting or based on member input of a model portfolio;
any module to track and store investment value of the investment club;
any regulatory compliance module to ensure the investment club retains its regulatory exemption from registration under securities and investment laws and regulations as the club scales to 1,000 members and beyond; and
any module to penalize members who are passive in managing club investments and who fail to take actions, wherein the module automatically assigns penalty points to each member based on a severity of a member's failure to act and the module terminates the member exceeding a number of penalty points over a predetermined period of time; and
an interface for information retrieval, using a computing device, to display member benefits in the investment club.

11. A method to operate and manage an investment club, comprising:
rendering a graphical interface on a member dashboard with a feedback indication to increase user group investment participation in the large-scale investment club;
receiving investment actions from members;
making group investment decisions based on member voting;
tracking and storing investment value of the investment club;
penalizing members who are passive in managing club investments;
rendering member benefits in the investment club; and,
conforming with regulatory compliance by ensuring the investment club retains regulatory exemption from registration with the required active investment participation or activity of each member.

12. The method of claim 11, comprising rewarding to active investment members who actively participate by assigning tokens to active investment members.

13. The method of claim 11, comprising updating a member data base module and member communications module to automatically track each member's investments.

14. The method of claim 11, comprising generating accounting reports and status notification to members.

15. The method of claim 11, comprising periodically requesting member action on predetermined items

16. The system of claim 1, comprising receiving a vote on investments or a vote on engaging a vendor to provide a service to members.

17. The method of claim 11, comprising penalizing a member whose participation is below a predetermined threshold. Members whose participation is in the bottom 2% will be sent a warning that they need to take care to maintain participation to avoid termination of their club membership.

18. The method of claim 17, comprising terminating membership or forfeiting a membership benefit.

19. The method of claim 11, comprising penalizing a member whose vote count is below a predetermined threshold without one or more predefined reasons.

20. The method of claim 11, comprising awarding reward tokens to members who actively participate in club investment decisions.
